(19) United States
(12) Patent Application Publication
(10) Pub. No.: US 2017/0161807 A1
(43) Pub. Date: Jun. 8, 2017

(54) SYSTEM AND METHOD FOR PROVIDING A BARTER SYSTEM IN A NETWORK ENVIRONMENT

(71) Applicant: Michael Paul Aielli, Austin, TX (US)

(72) Inventor: Michael Paul Aielli, Austin, TX (US)

(21) Appl. No.: 15/015,866

(22) Filed: Feb. 4, 2016

Related U.S. Application Data
(60) Provisional application No. 62/111,940, filed on Feb. 4, 2015.

(51) Int. Cl. G06Q 30/06

(52) U.S. Cl. CPC G06Q 30/0609

(57) ABSTRACT

Systems and methods for providing a barter system in a network environment. The systems and methods facilitate a transaction between two (traders) in a group of users in a communication network (such as the Internet) in which the transaction is for an exchange of goods/services. The first user would have access to all of the items the second users (from the group of potential second users) is offering and/or wanting, and then would make an offer of swapping particular goods of both the first and second users. The system and methods likewise facilitate a transaction between more than two users (such as a three-way swap) in an exchange of goods/services.

### CROSS-REFERENCE TO RELATED APPLICATIONS

This application claims priority to provisional U.S. Patent Application Ser. No. 62/111,940, filed on Feb. 4, 2015, entitled “System And Method For Providing A Barter System In A Network Environment,” which application (including the attachments to the Application) is hereby incorporated herein by reference in its entirety for all purposes.

### FIELD OF INVENTION

The present invention relates to systems and methods for providing a barter system in a network environment.

### BACKGROUND OF INVENTION

Bartering is one of the first forms of commercial transactions in that offered goods and services by one person was traded in exchange for the desired goods or services being offered by another person. Bartering continues to be popular, as reflected in the many garage sales, flea markets, and swap meets that exist. One major difficulty in the efficiency of a barter system is finding a match between people that each has things desired by the other.

With the advent of the Internet and e-commerce, many one way systems for selling goods on line have proliferated, as exemplified by such Internet sites as e-Bay.com, CraigsList.org, and Amazon.com. Method and systems for electronic barter have also been created, such as reflected in U.S. Pat. No. 6,993,511, issued to Himmelstein, and U.S. Patent Appl. Publ. No. 20060064409, to Hardwick. However, these electronic barter systems had limitations to their ability for its users to efficiently and effectively match with other users, particularly with comparing the large numbers of potential matches available. Accordingly, the need remains for an improved barter system.

### SUMMARY OF INVENTION

The present invention relates to systems and methods for providing a barter system in a network environment. The subject technology is directed a system and method of facilitating a transaction between two (or more) users in a group of users in a communication network (such as the Internet) in which the transaction is for an exchange of goods/services. In simpler terms, the technology would allow a user to look for someone to make a trade for services/goods. As this is an exchange of goods and services, the system facilitates the wants and needs of the users to match users with one another for potential exchanges. The user would have access to all of the items the second user (from the group of potential second users) is offering and then would make an offer of swapping particular goods of both the first and second users. The offer would be relayed to the second user who could then accept, decline, or make a counter-offer. If an offer or counter-offer is agreed to, the first and second user would then be given contact information such that they could interact physically to make confirm the goods/services and make the exchange.

The system also provides for swaps among more than two users (such as a three-way swap). In such instance the offer and counter-offers are routed among this group of users involved in the potential swap to facilitate agreement by all such users.

The system also provides for the ability to contact the other user (or users as the case may be) to facilitate agreement and also to allow the ability to view directly the goods/services being considered for exchange.

In general, in one aspect, the invention features a method of providing a barter system over an electronic network. The method includes the step of providing a plurality of traders access to the system over the electronic network. The method further includes the step of receiving data over the electronic network from the plurality of traders to provide a swap list and a want list for each of the traders in the plurality of traders. The swap list includes a first list of items that the trader indicated the trader possesses and can offer for trade. The want list includes a second list of items that the trader indicated the trader can receive in trade. The method further includes the step of receiving a search request over the electronic network from a first trader in the plurality to trade for a first item on the want list of the first trader. The method further includes the step of generating a listing identifying at first subset of the plurality of traders. The first subset includes at least some of the traders in the plurality of traders that have the first item on the swap list of the trader. The method further includes the step of transmitting signals over the electronic network to display the swap list of one or more of the traders in the first subset. The method further includes the step of selecting a set of one or more second traders including at least one trader in the first subset for generating an offer that could result in a trade in which the first user will receive the first item. The method further includes the step of transmitting signals over the electronic network to display a visual list trading table. The visual list trading table includes the swap list of the first trader and the swap list of each of the one or more second traders. The method further includes the step of receiving data over the electronic network to select items from each of the first trader swap list and the one or more second traders swap lists to generate an offer to be made to the one or more second traders. The method further includes the step of transmitting the generated offer over the electronic network to the one or more second traders. The method further includes the step of receiving a response over the electronic network from the one or more second traders. The response is (i) an acceptance, (ii) a non-acceptance without a counter-offer, (iii) a non-acceptance with a counter-offer, or (iv) (in response to an open offer) a second trader offer.

Implementations of the invention can include one or more of the following features:

The set of one or more second traders can be one second trader.

The set of one or more second traders can be two second traders.

The response can be a counter-offer. The method can further include receiving and transmitting one or more additional counter-offers over the electronic network among the first trader and the one or more second traders exchange in which one of the additional counter-offers is accepted by the first trader and the one or more second traders.

The visual list trading table can include (i) text describing the items on the swap list and (ii) one or more photographs of the items on the swap list.

At least some of the signals and the data can be transmitted to or received from a smart phone of one or more of the first traders and the one or more second traders.

The display of the swap list of one or more of the traders in the first subset can be sortable.

The first trader and one of the one or more the traders in the first subset can be operatively connected to communicate via a secure teleconference.

The secure teleconference can be a secure video conference.

The first trader and at least one of the one or more second traders can be operatively connected to communicate via a secure teleconference.

The transmitting of the generated offer over the electronic network to the one or more second traders can include an e-mail sent to the one or more second traders.

The method can further include transmitting to the first trader over the electronic network a confirmation of the transmitting the generated offer over the electronic network to the one or more second traders.

The method can further include receiving data to register the plurality of traders to provide access to the system by the plurality of traders.

The step of receiving data to register the plurality of traders can include receiving a username, password, and contact information for each of the plurality of traders.

The response can be a second trader offer made in response to an open offer. The method can further include receiving a response over the electronic network from the first trader, wherein the response is (i) an acceptance, (ii) a non-acceptance without a counter-offer, or (iii) a non-acceptance with a counter-offer.

In general, in another aspect, the invention features a system that includes one or more servers in communication with user devices over an electronic network. The one or more servers include a processor configured to provide a plurality of traders access to the system over the electronic network. The processor further configured to receive data over the electronic network from the plurality of traders to provide a swap list and a want list for each of the traders in the plurality of traders. The swap list includes a first list of items that the trader indicated the trader possesses and can offer for trade. The want list includes a second list of items that the trader indicated the trader can receive in trade. The processor further configured to receive a search request over the electronic network from a first trader in the plurality to trade for a first item on the want list of the first trader. The processor further configured to generate a listing identifying at first subset of the plurality of traders. The first subset includes at least some of the traders in the plurality of traders that have the first item on the swap list of the trader. The processor further configured to transmit signals over the electronic network to display the swap list of one or more of the traders in the first subset. The processor further configured to select a set of one or more second traders including at least one trader in the first subset for generating an offer that could result in a trade in which the first user will receive the first item. The processor further configured to transmit signals over the electronic network to display a visual list trading table. The visual list trading table includes the swap list of the first trader and the swap list of each of the one or more second traders. The processor further configured to receive data over the electronic network to select items from each of the first trader swap list and the one or more second traders swap lists to generate an offer to be made to the one or more second traders. The processor further configured to transmit the generated offer over the electronic network to the one or more second traders. The processor further configured to receive a response over the electronic network from the one or more second traders. The response is (i) an acceptance, (ii) a non-acceptance without a counter-offer, (iii) a non-acceptance with a counter-offer, or (iv) (in response to an open offer) a second trader offer.

Implementations of the invention can include one or more of the following features:

The set of one or more second traders can be one second trader.

The response can be a counter-offer. The processor can be further configured to receive and transmit one or more additional counter-offers over the electronic network among the first trader and the one or more second traders exchange in which one of the additional counter-offers is accepted by the first trader and the one or more second traders.

The response can be a second trader offer made in response to an open offer. The processor can be further configured to receive a response over the electronic network from the first trader, wherein the response is (i) an acceptance, (ii) a non-acceptance without a counter-offer, or (iii) a non-acceptance with a counter-offer.

In general, in another aspect, the invention features a computer-readable media containing instructions for configuring one or more processors to provide a method of providing barter system over an electronic network. The method includes the step of providing a plurality of traders access to the system over the electronic network. The method further includes the step of receiving data over the electronic network from the plurality of traders to provide a swap list and a want list for each of the traders in the plurality of traders. The swap list includes a first list of items that the trader indicated the trader possesses and can offer for trade. The want list includes a second list of items that the trader indicated the trader can receive in trade. The method further includes the step of receiving a search request over the electronic network from a first trader in the plurality to trade for a first item on the want list of the first trader. The method further includes the step of generating a listing identifying at first subset of the plurality of traders. The first subset includes at least some of the traders in the plurality of traders that have the first item on the swap list of the trader. The method further includes the step of transmitting signals over the electronic network to display the swap list of one or more of the traders in the first subset. The method further includes the step of selecting a set of one or more second traders including at least one trader in the first subset for generating an offer that could result in a trade in which the first user will receive the first item. The method further includes the step of transmitting signals over the electronic network to display a visual list trading table. The visual list trading table includes the swap list of the first trader and the swap list of each of the one or more second traders. The method further includes the step of receiving data over the electronic network to select items from each of the first trader swap list and the one or more second traders swap lists to generate an offer to be made to the one or more second traders. The method further includes the step of transmitting the generated offer over the electronic network to the one or more second traders. The method further includes the step of receiving a response over the electronic network from the one or more second traders. The response is (i) an acceptance, (ii) a non-acceptance without a counter-offer, (iii) a non-acceptance with a counter-offer, or (iv) (in response to an open offer) a second trader offer.

Implementations of the invention can include one or more of the following features:

The set of one or more second traders can be one second trader.

The response can be a counter-offer. The method can further include receiving and transmitting one or more additional counter-offers over the electronic network among the first trader and the one or more second traders exchange in which one of the additional counter-offers is accepted by the first trader and the one or more second traders.

The response can be a second trader offer made in response to an open offer. The method can further include receiving a response over the electronic network from the first trader, wherein the response is (i) an acceptance, (ii) a non-acceptance without a counter-offer, or (iii) a non-acceptance with a counter-offer.

In general, in another aspect, the invention features a method of providing a barter system over an electronic network. The method includes the step of providing a plurality of traders access to the system over the electronic network. The method further includes the step of receiving data over the electronic network from the plurality of traders to provide a swap list and a want list for each of the traders in the plurality of traders. The swap list includes a first list of items that the trader indicated the trader possesses and can offer for trade. The want list includes a second list of items that the trader indicated the trader can receive in trade. The method further includes the step of receiving a search request over the electronic network from a first trader in the plurality to trade a first item on the swap list of the first trader. The method further includes the step of generating a listing identifying at first subset of the plurality of traders, wherein the first subset includes at least some of the traders in the plurality of traders that have the first item on the want list of the trader. The method further includes the step of transmitting signals over the electronic network to display the swap list of one or more of the traders in the first subset. The method further includes the step of selecting a set of one or more second traders including at least one trader in the first subset for generating an offer that could result in a trade in which the first user will trade away the first item. The method further includes the step of transmitting signals over the electronic network to display a visual list trading table, wherein the visual list trading table includes the swap list of the first trader and the swap list of each of the one or more second traders. The method further includes the step of receiving data over the electronic network to select items from each of the first trader swap list and the one or more second traders swap lists to generate an offer to be made to the one or more second traders. The method further includes the step of transmitting the generated offer over the electronic network to the one or more second traders. The method further includes the step of receiving a response over the electronic network from the one or more second traders. The response is (i) an acceptance, (ii) a non-acceptance without a counter-offer, (iii) a non-acceptance with a counter-offer, or (iv) (in response to an open offer) a second trader offer.

### DESCRIPTION OF DRAWINGS

FIG. 1 is an illustration of a display of a visual dual list trading table utilized in an embodiment of the present invention.

FIG. 2 is a diagram showing steps of a method for an embodiment of the present invention

FIG. 3 is an illustration of a display of a registration page utilized in an embodiment of the present invention.

FIG. 4 is an illustration a display of an item information input page utilized in an embodiment of the present invention.

FIG. 5 is an illustration of a display of a second trader's swap list providing more detailed information about that second trader's items utilized in an embodiment of the present invention.

FIG. 6 illustrates a display of a two-way video conference utilizing an embodiment of the present invention.

FIG. 7 illustrates a display of a collection of multiple traders' swap lists that can be used for sorting utilizing an embodiment of the present invention.

FIG. 8 is a diagram showing steps of the offer/acceptance protocol for an embodiment of the present invention.

FIG. 9 illustrates a display of a confirmation to a trader that an offer has been sent using an embodiment of the present invention.

FIG. 10 illustrates an e-mail communication received by a trader generated by an embodiment of the present invention.

FIG. 11 illustrates a display showing the visual list trading table with the option elections for the trader receiving for the offer utilizing an embodiment of the present invention.

FIG. 12 is a diagram showing steps of the offer/acceptance protocol for an embodiment of the present invention using an open offer.

FIG. 13 is a photograph of a pair of smart phones being used to facilitate a trade using an embodiment of the present invention.

FIG. 14A illustrates the swap lists and want lists of three traders for trading using an embodiment of the present invention.

FIG. 14B illustrates the results of a three-way trade of the traders illustrated in FIG. 14A using an embodiment of the present invention.

FIG. 15 is a schematic diagram of a system for an embodiment of the present invention.

### DETAILED DESCRIPTION

The present invention relates to systems and methods for providing a barter system in a network environment. A system and method is implemented for facilitating a transaction between two users in a group of users in a communication network in which the transaction is for an exchange of goods/services.

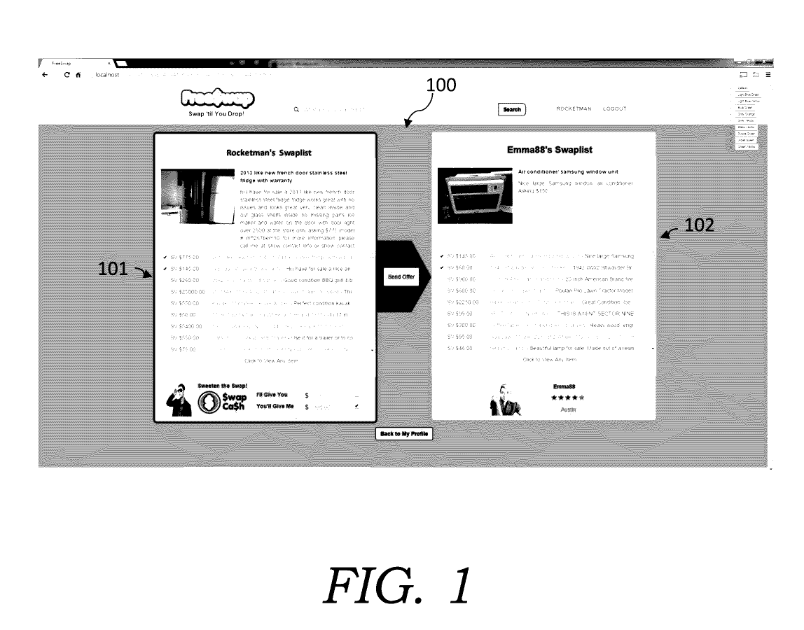

The invention utilizes a visual dual (or more) list trading table (the “visual list trading table”) designed for the quick and convenient trading and bartering of items (i.e., goods and/or services). The visual list trading table format has two (or more) separate and individual lists of items (called “swap lists”) available for trade, each swap list belonging to separate site-registered users (also known as “traders,” i.e., a first trader and a second trader), with the swap lists displayed side-by-side on the screen together. The visual list trading table format allows offers and counter offers to be made and exchanged (such as via e-mail or other electronic communication) back and forth between site-registered users. FIG. 1 is an illustration of a webpage display of a visual list trading table 100, with the trading table having a first trader's swap list 101 and the second trader's swap list 102.

The visual list trading table format concept is unique. Several advantages of the visual list trading table format are immediately apparent, most notably being that (1) it immediately dispenses with the first question asked in any trade, by either party: “What do you have to trade?”; (2) all items have a listed trade value, along with a picture and description of the item that is instantly viewable to both the first trader and the second trader; (3) all offers (as well as counter offers, accepted offers, declined offers, and withdrawn offers) are made where site-linked “screen-shots” of the dual-list screen (visual list trading table format) can e-mailed, or other electronic communication, among the traders, allowing all terms of the trade to be seen (i.e., visualized) immediately (what item(s) is being offered, the value of each offer) along with the ability of the traders to see other possible items available for trade. This can be done simply by opening an e-mail, and without having to be logged onto the visual list trading table format website; and (4) an entire trade can be negotiated and closed (countered, declined, or withdrawn) in a fraction of the time compared to current online trading.

In addition, the visual list trading table format is visually exciting and fun, stimulating the entire trading process from start to finish, quickly and efficiently. Dozens of items (possibly hundreds, or thousands, depending upon the size of a trader's swap list) are instantly available to view, consider, and trade for by the traders (i.e., the first trader and the second trader).

To date, trading on the Internet remains difficult, cumbersome, time consuming, and oftentimes totally ineffective. The visual list trading table upgrades the entire online trading methodology, empowering the traders with the ability to instantly choose (and trade) from a list of available items immediately, in real-time. This use of the visual list trading table is new. It is far superior and effective method to trade online than any other currently existing format.

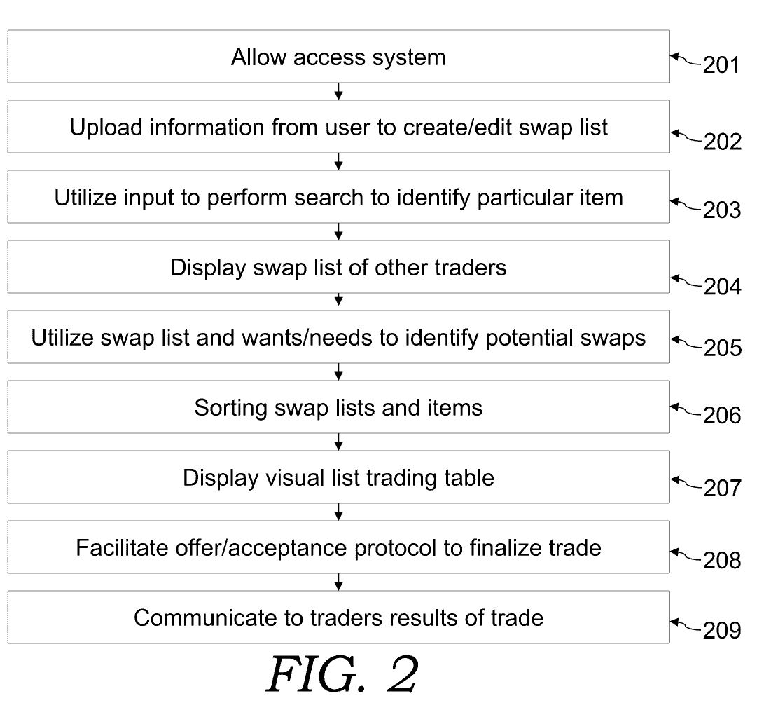

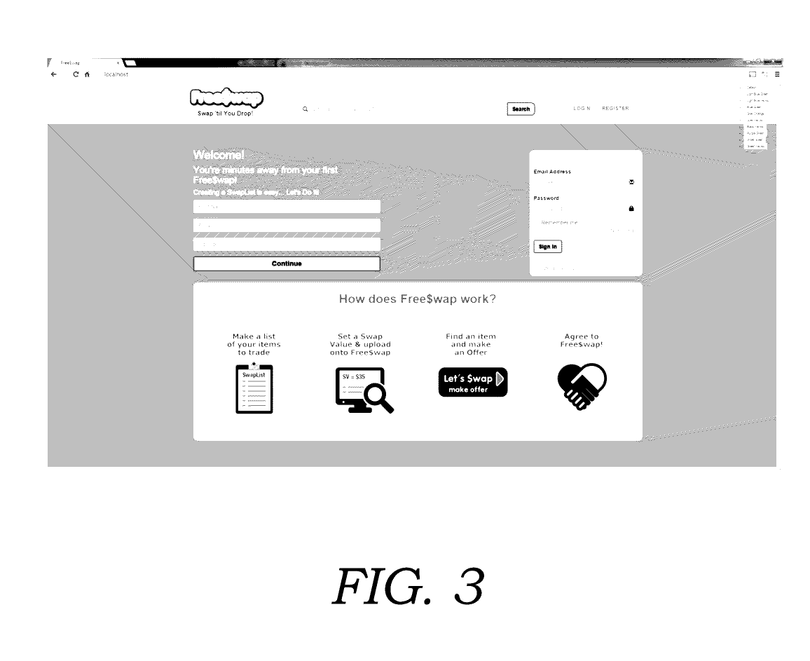

Referring to FIG. 2, in embodiments of the invention, the method includes creating a user account for the group of users, including, receiving, at the server, a profile of information about each of the users. This allows the user to access the system, as shown in step 201. FIG. 3 shows an illustration of a display of a registration page for the use by a user to create and account. The registration can include, for example, a username, password, contact information, and agreement to the terms and conditions of the system.

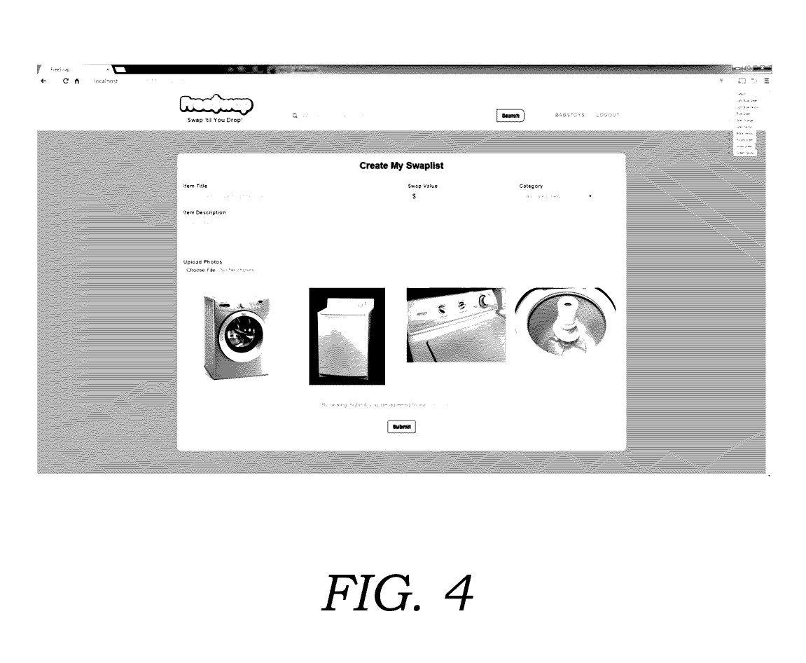

Once the system registers a user, information is received from the user to create that user's swap list as shown in step 202 of FIG. 2. This can be done, for example, by uploading pictures and descriptions of items that the user wishes to trade. Such swap list can be updated either by the user or automatically by the system (such as due to the removal of the item from the swap list because the item has been traded). FIG. 4 shows an illustration of a display of an item information input page that can be utilized to input the information (text, pictures, etc.) for the swap list.

For each user, the profile of information including information about one or more goods/services listed by that user. The information about the one or more goods and services can include both illustrations, pictures (i.e., photographs), and/or written descriptions of each of the goods/services, such as shown in FIG. 1. A target price can also be included within the information of the one or more goods/services. As discussed further below, the user includes the user's wants and needs that will assist in facilitating trades between users.

Once the user has uploaded all of the user's trade items on to the system, the swap list is created. In step 203, the method further includes providing, to a first user in the group of users, a searchable interface that allows one user (a searching trader) to identify a particular type of goods/services within the information of the users in the group of users. All of the items on any swap list can be searched for via the site search database using search techniques known in the art.

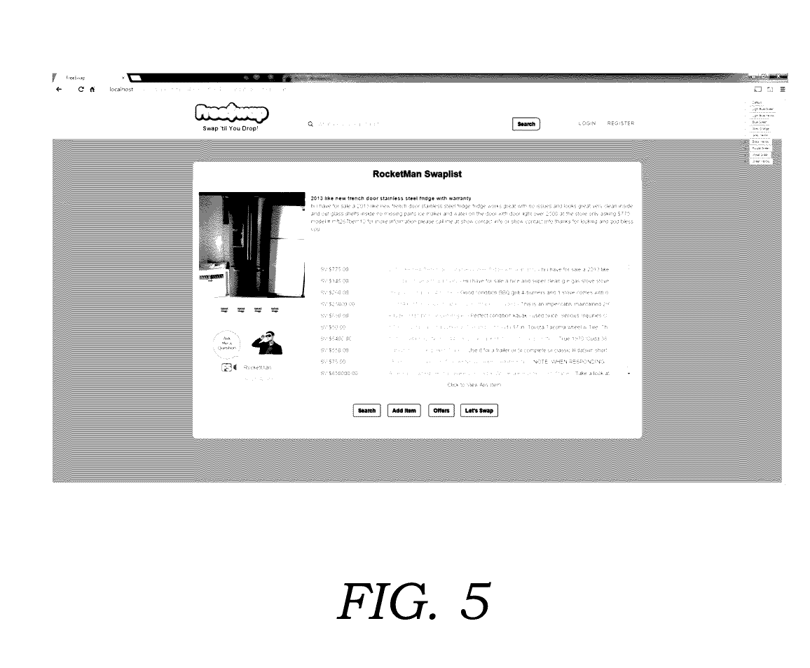

Once any search item is selected to be viewed, in step 204, the entire swap lists associated with that search item appears on screen, with the subject search item prominently displayed at the top of the swap lists. I.e., once the first trader identifies a particular item, the system identifies the second trader associated with that item and then displays the second trader's entire swap list. Every item on any other trader's swap list can viewed by any registered user (i.e., first trader), and this swap list visual display and comparison becomes a focus of all offers and transactions desired to be made. FIG. 5 illustrates a display of a second trader's swap list providing more detailed information about that second trader's items.

In a different search and display of steps 203-204, the search could be performed by the first trader to identify other traders who are interested in items that the first trader has on its swap list (i.e., by searching the other users who have such items listed on their want list). The first trader than displays the swap lists to determine what items the identified other traders have that are acceptable to receive in trade.

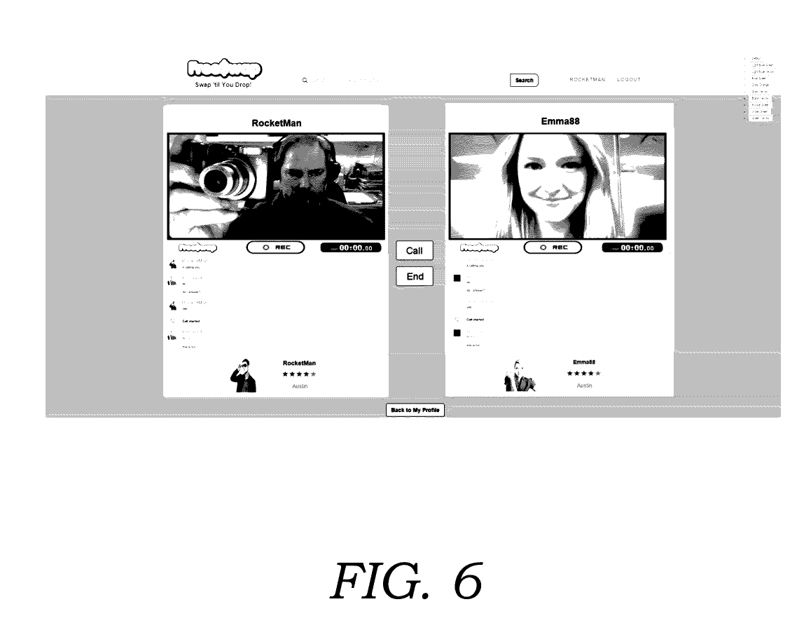

For instance, the traders can then contact each other via e-mail, such as by clicking on an “Ask Me A Question” bubble, via video, such as by clicking on the FS video icon, or other electronic means. When the FS video icon is selected, a two-way video conferencing can be established through the website connecting the two users securely (and, if desired by one or both users, with certain animosity). FIG. 6 illustrates a display a two-way video conference using the system.

In step 205 of FIG. 2, this identification of particular types of goods and services can take into account the wants and needs of the users to match users with one another for potential exchanges. This facilitates the swapping as it allows the first user to focus on other users that (a) have items that the first user wants and needs and (b) have wants and needs that the first user can address. This also provides for multiple user swaps, such as a three-way swap, by matching the various users' needs and wants. I.e., a first user can identify a second and third user in which

(1) the second user has goods/services that the first user wants/needs;

(2) the third user has goods/services that the second user wants/needs; and

(3) the first user has goods/services that the third user wants/needs.

Moreover, the multiple-swap could include swaps where one user is supplying goods/services to more than one other user in the exchange.

The method discussed below further is directed to a swap between two-users. However, as the method can be extended to more than two users, the method is adjusted to take these additional users into account.

In step 206 of FIG. 2, the method further includes providing, to the first user in the group of users, displayable entries sortable using criteria to allow the user to review the selection goods/services identified for the particular type of goods/services within the information of the users in the group of users.

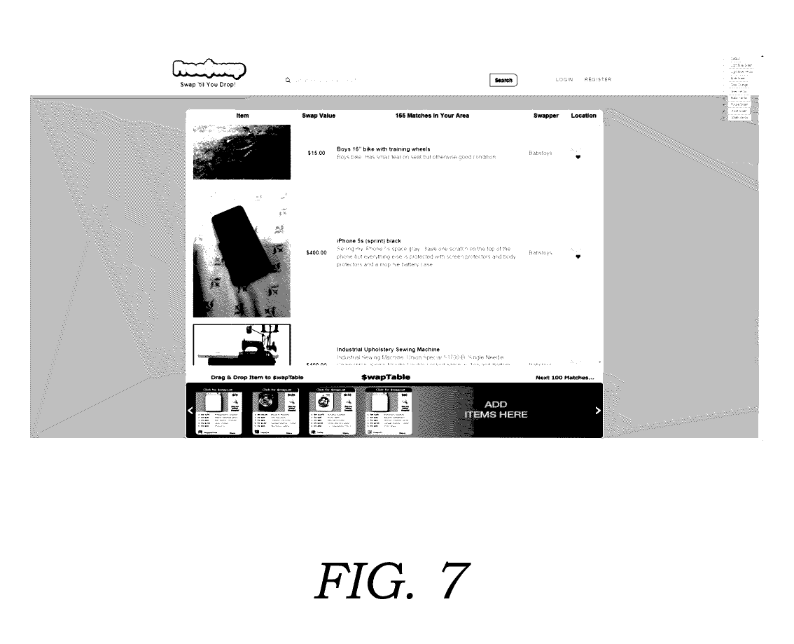

When a first trader is interested in viewing swap lists of several other traders, the system can utilize the swap table functionality to allow the first user to collect (such as by drag and drop) swap lists of multiple traders to an area of the screen where the preferred swap lists can be collected, displayed, and recalled for quick and easy viewing. FIG. 7 illustrates a display of a collection of multiple traders' swap lists that can be used for sorting.

In step 207 of FIG. 2, responsive to the first user's selection of a second user who has goods/services for the particular type of goods/service, the method further includes a side-by-side display of (i) the list of goods/services of the first user in the first user's profile and (ii) the list of goods/services of the first user in the first user's profile. The side-by-side comparison can include a brief listing of the goods/services and links to information of the goods/services of the first and second users. As noted above, FIG. 1 is an illustration of a webpage display of a visual list trading table 100.

Responsive to the first user's selection, the method further includes grouping of one or more of the first user's goods/services (the first user's group) and grouping of one or more of the second user's goods/services (the second user's group). Optionally, the first user can include cash amounts in one of the user's groups.

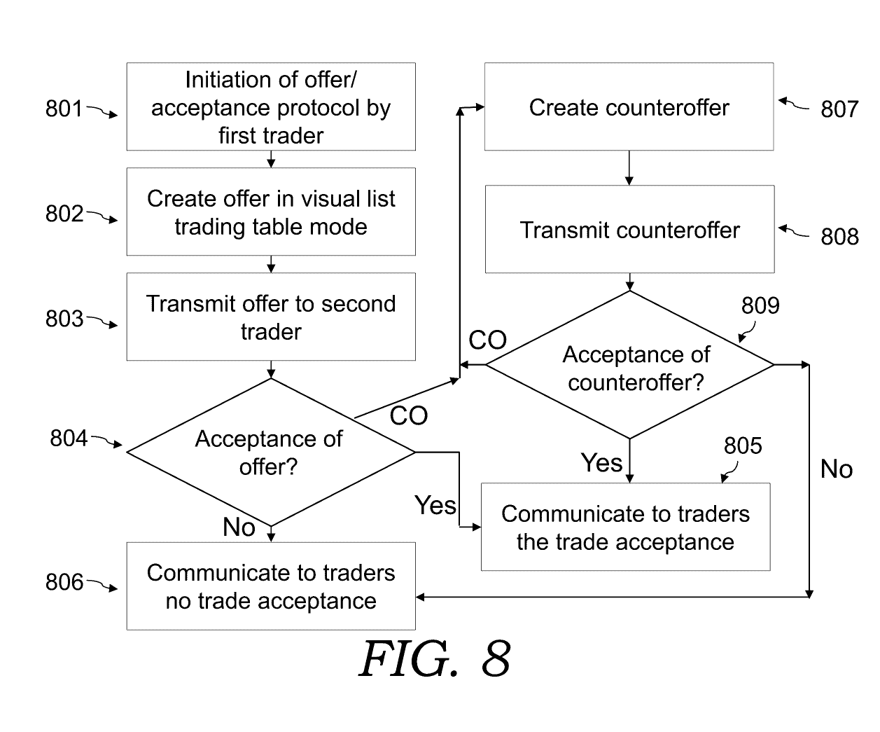

In step 208 of FIG. 2, the method includes facilitating the offer/acceptance protocol to finalize the trade. FIG. 8 illustrates an embodiment of the offer acceptance protocol that can be used.

In step 801 of FIG. 8, when a first trader locates an item that the trader wishes to submit an offer on, the first trader can begin the offer/acceptance protocol. For example, the first trader can click on the “Let's Swap” button displayed at the bottom of the swap list the first trader is viewing (that contains the item of interest) and, in step 802, the process converts into visual list trading table mode (such as shown in FIG. 1), displaying both the first traders and the second traders complete swap lists, side-by-side on the screen. Using both swap lists, the first trader constructs an offer by placing a check mark (or other identifier) next to the appropriate items on both swap lists. I.e., the first trader places a check mark next to the items on the first trader's own swap list that the first trader is offering for trade, and also places a check mark next to the items on the second trader's swap list that the first trader wishes to trade for. Full or partial cash offers can be included in the trade as well.

In step 803, responsive to the first trader's selection, the method of the offer/acceptance protocol includes transmitting the offer to the second trader for first user to exchange the first trader's group of items for the second trader's group of items (as specified by the first trader).

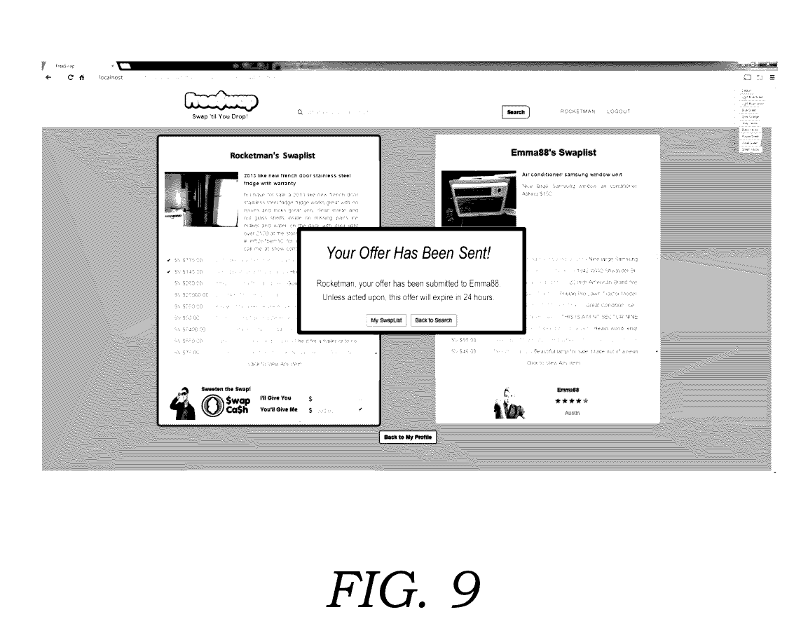

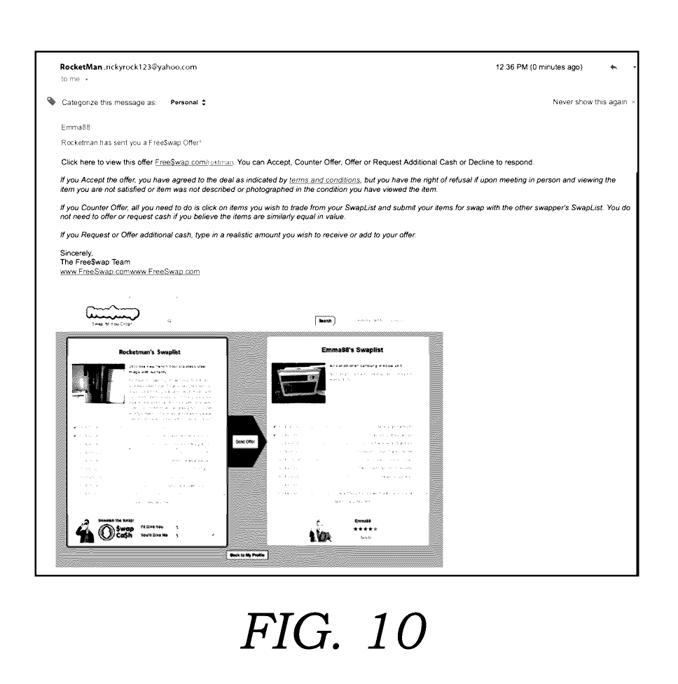

For example, when the first trader is satisfied with the first trader's selected items and is ready to send its offer to the second trader, the first user to transmit the offer, such as by clicking a “Send Offer” button. The system then simultaneously notifies the first trader (typically on screen, such as shown on FIG. 9) and with an e-mail or other electronic communication) that the first trader's offer has successfully been sent to the second trader, and notifies the second trader as well with an e-mail or other electronic communication, such as an e-mail containing a site-linked screen-shot of the first trader's exact offer. This can be sent with the visual list trading table illustrating the trade. FIG. 10 is an illustration of such an e-mail communication received by the second trader.

Responsive to the first trader's offer, in step 804, the method further includes that the second user can elect to accept (“Yes”), decline without counter-offer (“No”), or decline with a counter-offer (“CO”) to first trader. For example, after the offer is received by the second trader, the second trader can:
(1) Accept the offer by pressing an “Accept Offer” button.
(2) Decline the offer by pressing a “Decline Offer” button (or, in some embodiments by not responding to the offer in a preset time. This time can either be set by the first trader or by a default time, such as to expire automatically in 24 hours.
(3) Counter the offer by pressing a “Counter Offer” button.

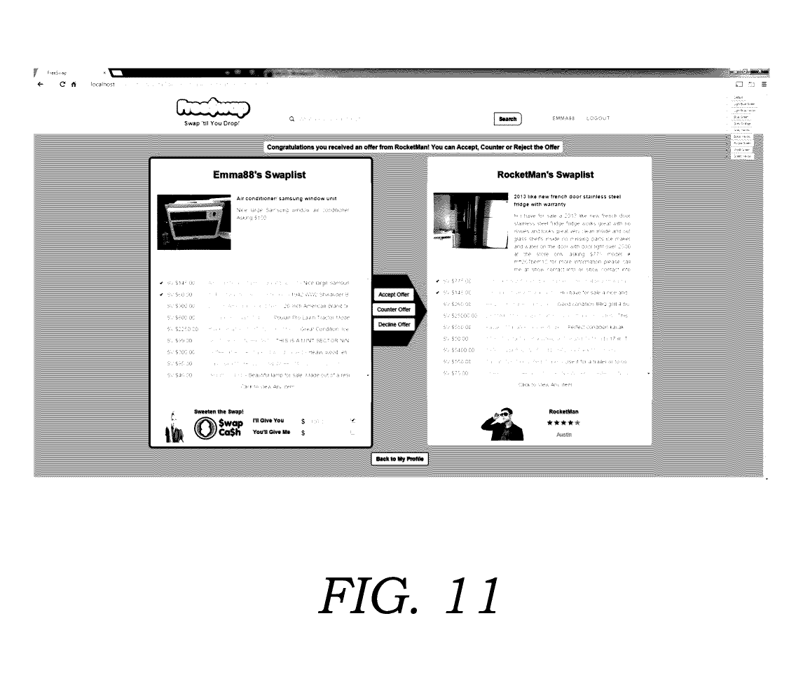

FIG. 11 illustrates a display showing the visual list trading table with the above identified option selections for the second trader.

To the extent the second user elects to accept the offer, in step 805, the method further provides that the traders are informed of the acceptance and further information from the first and second traders are provided to allow first and second traders to conduct the agreed exchange. (The actual manner in which the first and second traders conduct the agreed exchange of the items is then done in any manner that the first and second traders decide. While the present invention can facilitate communications among the first and second traders to determine the details of this exchange, generally the exchange of the items is perform independent of the present invention).

To the extent the second user elects to decline the offer without a counter-offer, in step 806, the method further provides that the first user is informed of the non-acceptance. In addition, such declining can include simply ignoring the offer, which is considered declined after a pre-set amount of time. Such steps of communicating to the traders of the results of the trade (i.e., acceptance or decline without counter-offer) are also shown in FIG. 2 in step 209.

If declined with a counteroffer, in step 807, the trader who had received (but declined) the offer is provided side-by-side display of (i) the list of goods/services of the first trader in the first trader user's profile and (ii) the list of goods/services of the second trader in the second trader's profile. That trader can then modify the items in the trade for the counter-offer modifying one or both of items in the first trader's group and the second trader's group).

For example, the second trader can then checking the boxes next to the items and cash amount (if any) of their choice.

In step 808, the counter-offer from offering trader (such as the second trader) is transmitted to the other trader (such as the first trader).

In step 809, the other trader now can elect to elect to accept (“Yes”), decline without counter-offer (“No”), or decline with another counter-offer (“CO”). The process than proceeds to steps 805, 806, and 807, respectively.

The counter-offer process through step 807, then repeats until the first and second trader either come to terms and accept a trade (and proceed to step 805) or do not come to terms and decline a trade without counter-offer (and proceed to step 806).

Concurrent with these steps shown in FIG. 8, the two (or more) of the traders can contact each other, such as by e-mail, telephone call, video conferencing, etc. to interact directly, and also to further view the goods and services being exchanged. For instance, as discussed above and illustrated in FIG. 6, a two-way video conference can be established through the system to connect two users so that they can compare the goods and services to arrive at an agreeable exchange. By providing this interaction, this reduces the possibility of a misunderstanding or miscomprehension of the goods/services being exchange, which could become an issue at the time of the physical exchange of the goods/services.

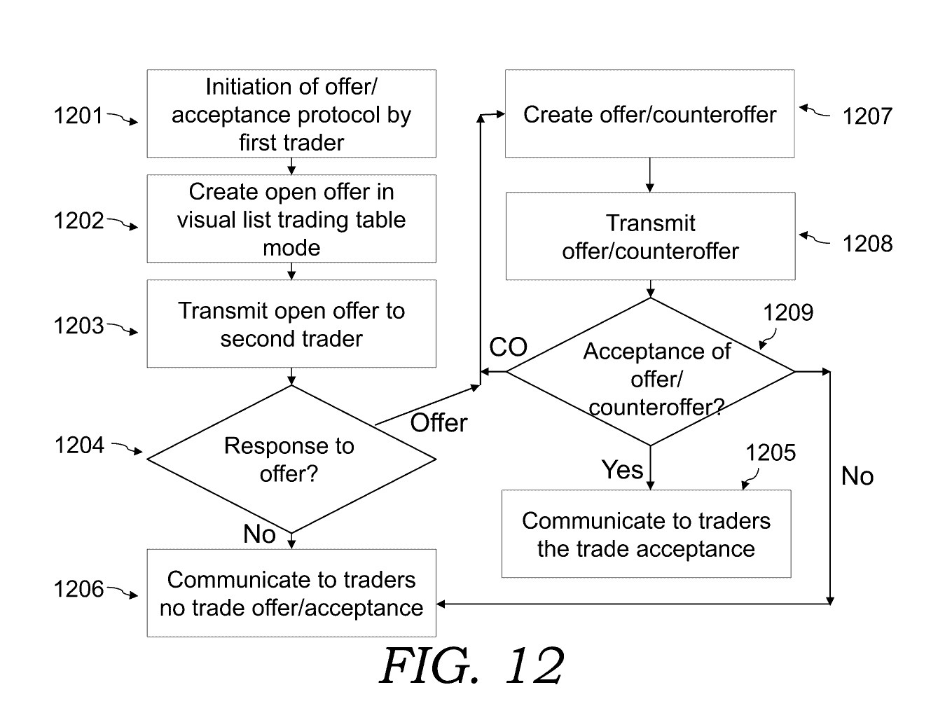

FIG. 12 is a diagram showing steps of the offer/acceptance protocol for an embodiment of the present invention using an open offer. An “open offer” is an offer in which the first trader sends the second trader an offer to trade but without the complete exchange. Such open offer is an offer to the second trader to make an offer to the first trader after indicating the complete exchange. For instance, the first trader may submit to the second trader (or traders as the case may be) the swap lists with an indication of the item(s) that the first trader wishes to trade for that the second trader has and leave it to the second trader to review the first traders swap list to determine what the second trader wants in return. Alternatively, for instance, the first trader may submit to the second trader (or traders as the case may be) the swap list with an indication that the first trader has one or more items on the first traders swap list that the second trader has indicated it wants on the second trader's want list. The first trader would then leave it to the second trader what the second trader from the second trader's own list is willing to provide in exchange.

Steps 1201-1209 in FIG. 12 are similar to the steps 801-809 in FIG. 8 described above, with the following general differences. In step 1202, an open offer is created. Again, this is not an offer that can be accepted, but rather an open offer to make an offer to the first trader.

Once the open offer is transmitted to the second trader (or second traders) in step 1203, it can only be responded to in step 1204, not accepted. The second trader can decline the open offer (or not respond), which would then proceed to step 1206, in which the traders are told that there is no offer being made.

The second trader can alternatively decide to make an offer. In step 1207, the second trader creates the offer, which is then transmitted to the first trade in step 1208. At this point, the procedure become the same as in FIG. 8, i.e., further steps 1205-1209 correspond with steps 805-809 in FIG. 8 going forward as described above.

In some embodiments of the present invention, the open offer can be made by the first trader simply submitting to the second trader an inquiry requesting whether there is anything on the first trader's swap list that the second trader would like to trade for.

In further embodiments of the present invention, the system and method includes that a particular trader is: (a) prevented from offering in a separate trade any of the particular trader's items that are presently being included in any offer extended by that party, and (b) prevented from accepting any trade in which any of the particular trader's items would be included.

In further embodiments of the present invention, once a trade has been accepted, all items are then prevented from further trade by the respective traders unless the respective traders execute a full release (indicating that all respective traders have agreed to cancel the trade or modify the trade to not include one or more of the pertinent items).

The system utilizing the visual list trading table is a synergistic process, one that instantly excites and rewards both the traders with endless possibilities in which to make a trade easily and quickly. The simple desire to trade for a single one-on-one item has now morphed into a virtual “shopping-cart” (or warehouse full) of available items to choose from and trade for.

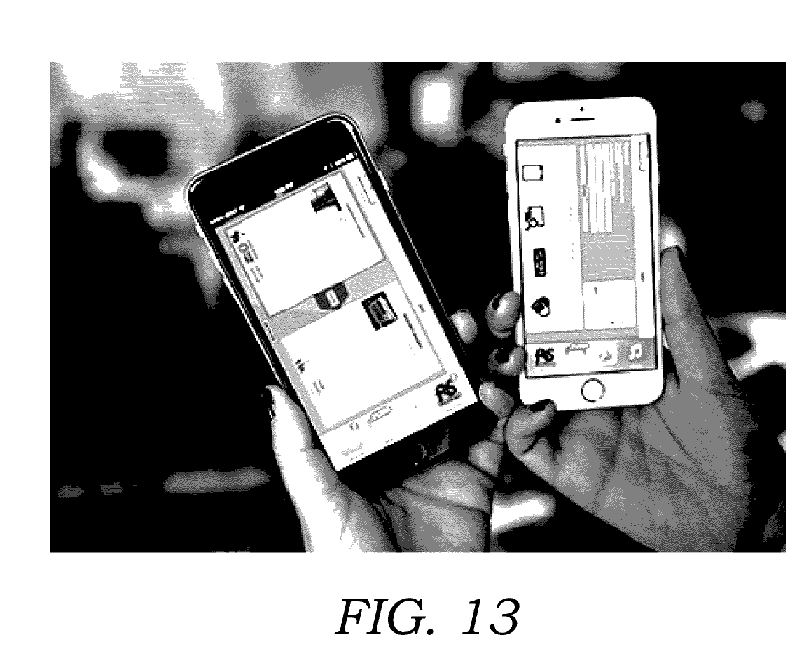

The visual list trading table format is screen “responsive” and perfectly suited for smart phone mobility, allowing trading to be performed anywhere and everywhere. FIG. 13 is a photograph of a pair of smart phones being used to facilitate a trade using the system described herein.

The system can be used to facilitate trades by having the traders provide their needs/wants with their trade list so that other traders can obtain a better understanding of what items the other trade may be interested in bartering.

The search performed utilizing the system (in step 203) can take into account not only the items being searched by the searching trader, but also the items that the searching trader has to offer that may be of interest to those other traders with the item being searched. For instance, if a first trader is interested in a washing machine and dryer and has a camera to trade, the system would preferentially identify those traders having (a) a washing machine and dryer that meets the specifications of the first trader and (b) the needs/wants of the camera being offered for trade. Since the first party will generally have multiple items to barter, this preferential identification will facilitate interactions of traders having appropriate items to trade.

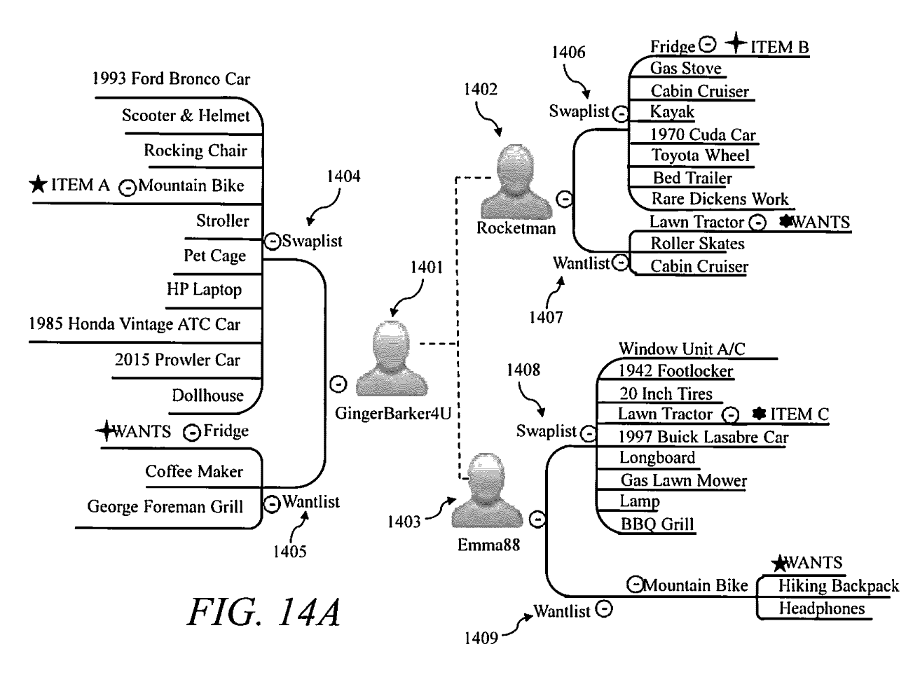

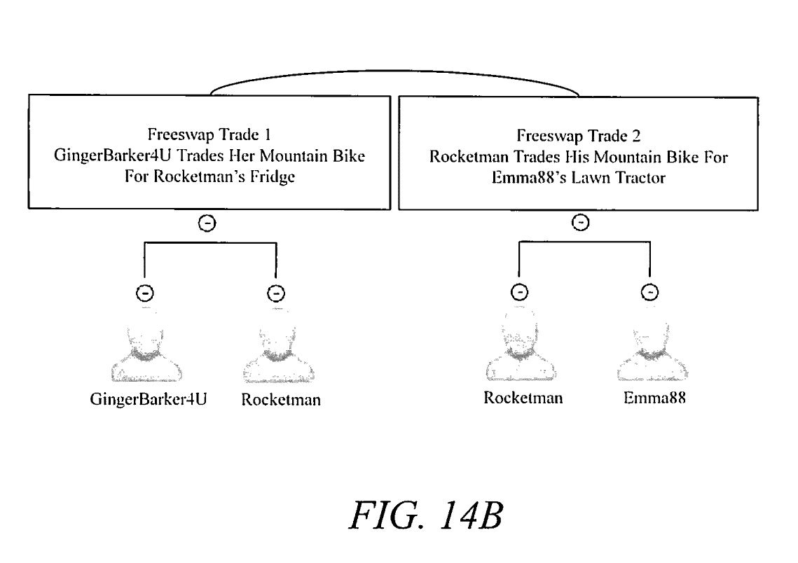

This feature can facilitate the system and method being utilized for more than two traders to implement a multi-party trade. FIG. 14A is an illustration of three traders 1401-1403. Trader 1401 has a swap list 1404 and a want list 1405. Trader 1402 has a swap list 1406 and a want list 1407. Trader 1403 has a swap list 1408 and a want list 1409.

As shown in FIG. 14A:
(1) Trader 1401 has a “Mountain Bike” listed on their swap list 1404, and Trader 1403 has a “Mountain Bike” listed on their want list 1409.
(2) Trader 1402 has a “Fridge” listed on their swap list 1406, and Trader 1401 has a “Fridge” listed on their want list 1405.
(3) Trader 1403 has a “Lawn Tractor” listed on their swap list 1408, and Trader 1402 has a “Lawn Tractor” listed on their want list 1407.

By identifying these wants/needs, Traders 1401-1403 can enter into a trade in which each obtains the respective item they want/need (i.e., Trader 1401 obtains a “Fridge,” Trader 1402 obtains a “Lawn Tractor, and Trader 1403 obtains a “Mountain Bike.”) as shown in FIG. 14B.

The examples provided herein are to more fully illustrate some of the embodiments of the present invention. It should be appreciated by those of skill in the art that the techniques disclosed in the examples which follow represent techniques discovered by the Applicant to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

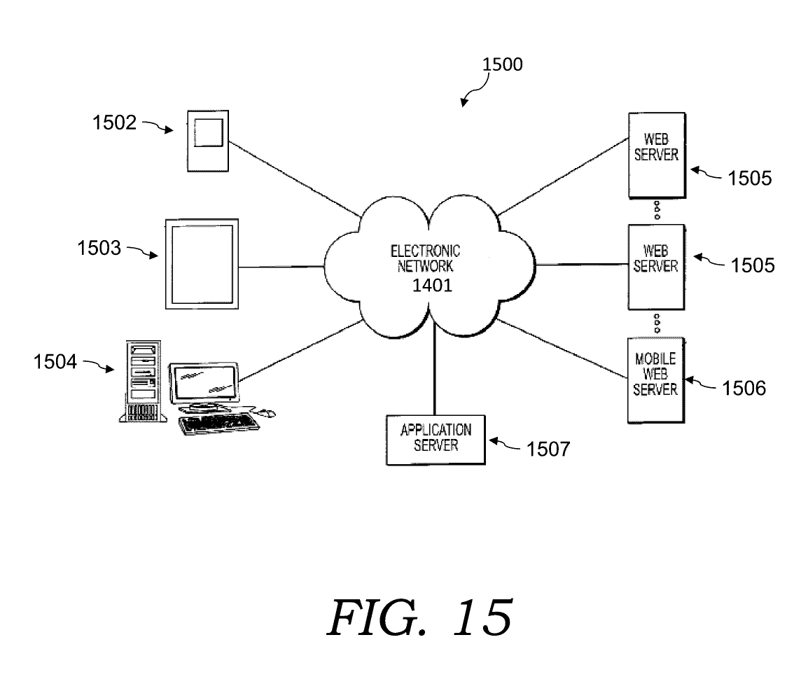

FIG. 15 is a schematic diagram of system 1500 for the present invention. Specifically, FIG. 15 illustrates exemplary system illustrates an exemplary system 1500 including a plurality of user devices 1502-1504, a plurality of web servers 1505-1506, and an application server 1506, all disposed in communication with an electronic network 1501, such as the Internet.

In one embodiment, user devices 1502-1504 may be owned and used by one or more people, who may be viewers of web pages over the Internet, either through a mobile browser or web browser stored on respective user devices. User devices 1502-1504 may include any type of electronic device configured to send and receive data/information over electronic network 1501. For example, each of user devices 1502 may include a mobile device, smartphone, and/or personal digital assistant (“PDA”) disposed in communication with electronic network 1501. Each of user devices 1503 may be a tablet computer or any other kind of touchscreen-enabled device disposed in communication with electronic network 1501. Each of user devices 1504 may be a personal computer, laptop, and/or server disposed in communication with electronic network 1501.

Each of user devices 1502-1504 may have a web browser and/or mobile browser installed for receiving and displaying electronic content received from one or more of web servers 1505-1506. Each of user devices 1502-1504 may have an operating system configured to execute a web or mobile browser, and any type of application, such as a mobile application. In one embodiment, user devices 1502-1504 may be configured to download applications and/or application content from application server 1507. In one embodiment, user devices 1502-1504 may be configured to download one or more applications from application server 1507, and execute those one or more applications to receive electronic content from one or more of web servers 1505-1506.

Web servers 1505-1506 (and also the application server 1507) may be owned and/or operated by any entities that maintain and disseminate the content of the swap lists and want lists of the traders as well as the information to perform the steps of the system discussed above, including in FIGS. 2 and 8. Thus, these entities may interact with user devices 1502-1504, DNS servers, ad servers, content distribution network servers, or any other servers through web servers 1505-1506 connected to electronic network 1501. Thus, these entities may be able to distribute the content of the swap lists and want lists of the traders to any other entities in the system 1500 of FIG. 15.

Any of user devices 1502-1504, web servers 1505-1506 and/or application servers 1507 may include any type or combination of computing systems, such as handheld devices, personal computers, servers, clustered computing machines, and/or cloud computing systems. In one embodiment, each of user devices 1502-1504, web servers 1505-1506, and/or application servers 1507 may be an assembly of hardware, including a memory, a central processing unit (“CPU”), and/or optionally a user interface. The memory may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. The CPU may include one or more processors for processing data according to instructions stored in the memory. The functions of the processor may be provided by a single dedicated processor or by a plurality of processors. Moreover, the processor may include, without limitation, digital signal processor (DSP) hardware, or any other hardware capable of executing software. The user interface may include any type or combination of input/output devices, such as a display monitor, touchpad, touchscreen, microphone, camera, keyboard, and/or mouse.

As described above, the presently disclosed systems and methods may be configured to manipulate electronic content, such as text, images, and other HMTL content received over the Internet. The content may take the form of a portrait or page layout that traditionally would be scrolled through up and down using traditional scrolling elements.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above.

What is claimed is:

1. A method of providing a barter system over an electronic network, the method comprising the steps of:
(a) providing a plurality of traders access to the system over the electronic network;
(b) receiving data over the electronic network from the plurality of traders to provide a swap list and a want list for each of the traders in the plurality of traders, wherein
(i) the swap list comprises a first list of items that the trader indicated the trader possesses and can offer for trade, and
(ii) the want list comprises a second list of items that the trader indicated the trader can receive in trade;
(c) receiving a search request over the electronic network from a first trader in the plurality to trade for a first item on the want list of the first trader;
(d) generating a listing identifying at first subset of the plurality of traders, wherein the first subset comprises at least some of the traders in the plurality of traders that have the first item on the swap list of the trader;
(e) transmitting signals over the electronic network to display the swap list of one or more of the traders in the first subset;
(f) selecting a set of one or more second traders comprising at least one trader in the first subset for generating an offer that could result in a trade in which the first user will receive the first item;
(g) transmitting signals over the electronic network to display a visual list trading table, wherein the visual list trading table comprises the swap list of the first trader and the swap list of each of the one or more second traders;
(h) receiving data over the electronic network to select items from each of the first trader swap list and the one or more second traders swap lists to generate an offer to be made to the one or more second traders;
(i) transmitting the generated offer over the electronic network to the one or more second traders; and
(j) receiving a response over the electronic network from the one or more second traders, wherein the response is selected from the group consisting of (i) an acceptance, (ii) a non-acceptance without a counter-offer, (iii) a non-acceptance with a counter-offer, and (iv) in response to an open offer, a second trader offer.

2. The method of claim 1, wherein the set of one or more second traders is one second trader.

3. The method of claim 1, wherein the set of one or more second traders are two second traders.

4. The method of claim 1, wherein the response is a counter-offer and the method further comprising:
(k) receiving and transmitting one or more additional counter-offers over the electronic network among the first trader and the one or more second traders exchange in which one of the additional counter-offers is accepted by the first trader and the one or more second traders.

5. The method of claim 1, wherein the visual list trading table comprises (i) text describing the items on the swap list and (ii) one or more photographs of the items on the swap list.

6. The method of claim 1, wherein at least some of the signals and the data is transmitted to or received from a smart phone of one or more of the first traders and the one or more second traders.

7. The method of claim 1, wherein the display of the swap list of one or more of the traders in the first subset is sortable.

8. The method of claim 1, wherein the first trader and one of the one or more the traders in the first subset are operatively connected to communicate via a secure teleconference.

9. The method of claim 1, wherein the secure teleconference is a secure video conference.

10. The method of claim 1, wherein the first trader and at least one of the one or more second traders are operatively connected to communicate via a secure teleconference.

11. The method of claim 1, wherein the transmitting of the generated offer over the electronic network to the one or more second traders comprises an e-mail sent to the one or more second traders.

12. The method of claim 1 further comprising transmitting to the first trader over the electronic network a confirmation of the transmitting the generated offer over the electronic network to the one or more second traders.

13. The method of claim 1 further comprising receiving data to register the plurality of traders to provide access to the system by the plurality of traders.

14. The method of claim 14, wherein the step of receiving data to register the plurality of traders comprises receiving a username, password, and contact information for each of the plurality of traders.

15. The method of claim 1, wherein the response is a second trader offer made in response to an open offer and the method further comprising:
(k) receiving a response over the electronic network from the first trader, wherein the response is selected from the group consisting of (i) an acceptance, (ii) a non-acceptance without a counter-offer, and (iii) a non-acceptance with a counter-offer.

16. A system comprising one or more servers in communication with user devices over an electronic network, the one or more servers comprising a processor configured to:
(a) provide a plurality of traders access to the system over the electronic network;
(b) receive data over the electronic network from the plurality of traders to provide a swap list and a want list for each of the traders in the plurality of traders, wherein
(i) the swap list comprises a first list of items that the trader indicated the trader possesses and can offer for trade, and
(ii) the want list comprises a second list of items that the trader indicated the trader can receive in trade;
(c) receive a search request over the electronic network from a first trader in the plurality to trade for a first item on the want list of the first trader;
(d) generate a listing identifying at first subset of the plurality of traders, wherein the first subset comprises at least some of the traders in the plurality of traders that have the first item on the swap list of the trader;
(e) transmit signals over the electronic network to display the swap list of one or more of the traders in the first subset;
(f) select a set of one or more second traders comprising at least one trader in the first subset for generating an offer that could result in a trade in which the first user will receive the first item;
(g) transmit signals over the electronic network to display a visual list trading table, wherein the visual list trading table comprises the swap list of the first trader and the swap list of each of the one or more second traders;
(h) receive data over the electronic network to select items from each of the first trader swap list and the one or more second traders swap lists to generate an offer to be made to the one or more second traders;
(i) transmit the generated offer over the electronic network to the one or more second traders; and
(j) receive a response over the electronic network from the one or more second traders, wherein the response is selected from the group consisting of (i) an acceptance, (ii) a non-acceptance without a counter-offer, (iii) a non-acceptance with a counter-offer, and (iv) in response to an open offer, a second trader offer.

17. The system of claim 16, wherein the set of one or more second traders is one second trader.

18. The system of claim 16, wherein the response is a counter-offer and the processor is further configured to:
(k) receive and transmit one or more additional counter-offers over the electronic network among the first trader and the one or more second traders exchange in which one of the additional counter-offers is accepted by the first trader and the one or more second traders.

19. The system of claim 16, wherein the response is a second trader offer made in response to an open offer and processor is further configured to:
(k) receive a response over the electronic network from the first trader, wherein the response is selected from the group consisting of (i) an acceptance, (ii) a non-acceptance without a counter-offer, and (iii) a non-acceptance with a counter-offer.

20. A computer-readable media containing instructions for configuring one or more processors to provide a method of providing barter system over an electronic network, the method comprising:
(a) providing a plurality of traders access to the system over the electronic network;
(b) receiving data over the electronic network from the plurality of traders to provide a swap list and a want list for each of the traders in the plurality of traders, wherein
(i) the swap list comprises a first list of items that the trader indicated the trader possesses and can offer for trade, and
(ii) the want list comprises a second list of items that the trader indicated the trader can receive in trade;
(c) receiving a search request over the electronic network from a first trader in the plurality to trade for a first item on the want list of the first trader;
(d) generating a listing identifying at first subset of the plurality of traders, wherein the first subset comprises at least some of the traders in the plurality of traders that have the first item on the swap list of the trader;
(e) transmitting signals over the electronic network to display the swap list of one or more of the traders in the first subset;
(f) selecting a set of one or more second traders comprising at least one trader in the first subset for generating an offer that could result in a trade in which the first user will receive the first item;
(g) transmitting signals over the electronic network to display a visual list trading table, wherein the visual list trading table comprises the swap list of the first trader and the swap list of each of the one or more second traders;
(h) receiving data over the electronic network to select items from each of the first trader swap list and the one or more second traders swap lists to generate an offer to be made to the one or more second traders;
(i) transmitting the generated offer over the electronic network to the one or more second traders; and
(j) receiving a response over the electronic network from the one or more second traders, wherein the response is selected from the group consisting of (i) an acceptance, (ii) a non-acceptance without a counter-offer, (iii) a non-acceptance with a counter-offer, and (iv) in response to an open offer, a second trader offer.

21. The computer-readable media of claim 20, wherein the set of one or more second traders is one second trader.

22. The computer-readable media of claim 20, wherein the response is a counter-offer and the method further comprises:
(k) receiving and transmitting one or more additional counter-offers over the electronic network among the first trader and the one or more second traders exchange in which one of the additional counter-offers is accepted by the first trader and the one or more second traders.

23. The computer-readable media of claim 20, wherein the response is a second trader offer made in response to an open offer and the method further comprising:
(k) receiving a response over the electronic network from the first trader, wherein the response is selected from the group consisting of (i) an acceptance, (ii) a non-acceptance without a counter-offer, and (iii) a non-acceptance with a counter-offer.

24. A method of providing a barter system over an electronic network, the method comprising the steps of:
(a) providing a plurality of traders access to the system over the electronic network;
(b) receiving data over the electronic network from the plurality of traders to provide a swap list and a want list for each of the traders in the plurality of traders, wherein
(i) the swap list comprises a first list of items that the trader indicated the trader possesses and can offer for trade, and
(ii) the want list comprises a second list of items that the trader indicated the trader can receive in trade;
(c) receiving a search request over the electronic network from a first trader in the plurality to trade a first item on the swap list of the first trader;
(d) generating a listing identifying at first subset of the plurality of traders, wherein the first subset comprises at least some of the traders in the plurality of traders that have the first item on the want list of the trader;
(e) transmitting signals over the electronic network to display the swap list of one or more of the traders in the first subset;
(f) selecting a set of one or more second traders comprising at least one trader in the first subset for generating an offer that could result in a trade in which the first user will trade away the first item;
(g) transmitting signals over the electronic network to display a visual list trading table, wherein the visual list trading table comprises the swap list of the first trader and the swap list of each of the one or more second traders;
(h) receiving data over the electronic network to select items from each of the first trader swap list and the one or more second traders swap lists to generate an offer to be made to the one or more second traders;
(i) transmitting the generated offer over the electronic network to the one or more second traders; and
(j) receiving a response over the electronic network from the one or more second traders, wherein the response is selected from the group consisting of (i) an acceptance, (ii) a non-acceptance without a counter-offer, (iii) a non-acceptance with a counter-offer, and (iv) in response to an open offer, a second trader offer.
